(19) United States
(12) Patent Application Publication
(10) Pub. No.: US 2025/0310066 A1
(43) Pub. Date: Oct. 2, 2025

(54) PILOT TONE STRUCTURE IN A DISTRIBUTED TONE RESOURCE UNIT (DRU) TONE PLAN

(71) Applicant: NEWRACOM, Inc., Irvine, CA (US)

(72) Inventors: Si-Chan NOH, Seoul (KR); Joonsoo LEE, Seoul (KR)

(73) Assignee: NEWRACOM, Inc., Irvine, CA (US)

(21) Appl. No.: 19/093,108

(22) Filed: Mar. 27, 2025

Related U.S. Application Data
(60) Provisional application No. 63/573,301, filed on Apr. 2, 2024.

(51) Int. Cl. H04L 5/00; H04L 27/26

(52) U.S. Cl. CPC H04L 5/0094; H04L 5/0041; H04L 27/261

(57) ABSTRACT

A method performed by an access point (AP) to receive uplink trigger-based physical layer protocol data units (PPDUs) from stations (STAs) in accordance with a distributed tone resource unit (dRU) tone plan for a distribution bandwidth. The method includes assigning dRUs to the STAs in the distribution bandwidth, wherein the dRU tone plan for the distribution bandwidth specifies a set of non-contiguous data tones for each of the dRUs, wherein the dRU tone plan for the distribution bandwidth further specifies pilot tones that are located at the same subcarrier indices as pilot tones specified by a regular non-distributed tone resource unit (rRU) tone plan for the distribution bandwidth. The method further includes soliciting the uplink trigger-based PPDUs from the STAs in accordance with the assignment and receiving the uplink trigger-based PPDUs from the STAs in the dRUs assigned to the STAs in accordance with the dRU tone plan for the distribution bandwidth.

### CROSS-REFERENCE TO RELATED APPLICATION

This application claims the benefit of U.S. Provisional Application No. 63/573,301, filed Apr. 2, 2024, titled “Pilot subcarriers structure of Distributed Tone RU (dRU)”, which is hereby incorporated by reference.

### TECHNICAL FIELD

The present disclosure generally relates to wireless communications, and more specifically, relates to the pilot tone structure in a distributed tone resource unit (dRU) tone plan.

### BACKGROUND

Institute of Electrical and Electronics Engineers (IEEE) 802.11 is a set of standards for implementing wireless local area network communication in various frequencies, including but not limited to the 2.4 gigahertz (GHz), 5 GHz, 6 GHz, and 60 GHz bands. These standards define the protocols that enable Wi-Fi devices to communicate with each other. The IEEE 802.11 family of standards has evolved over time to accommodate higher data rates, improved security, and better performance in different environments. Some of the most widely used standards include 802.11a, 802.11b, 802.11g, 802.11n, 802.11ac, and 802.11ax (also known as “Wi-Fi 6”). These standards specify the modulation techniques, channel bandwidths, and other technical aspects that facilitate interoperability between devices from various manufacturers. IEEE 802.11 has played an important role in the widespread adoption of wireless networking in homes, offices, and public spaces, enabling users to connect their devices to the internet and each other without the need for wired connections.

IEEE 802.11be, also known as “Wi-Fi 7”, is the next generation of the IEEE 802.11 family of standards for wireless local area networks. Currently under development, 802.11be aims to significantly improve upon the capabilities of its predecessor, 802.11ax/Wi-Fi 6, by offering even higher data rates, lower latency, and increased reliability. The standard is expected to leverage advanced technologies such as multi-link operation (MLO), which allows devices to simultaneously use multiple frequency bands and channels for enhanced performance and reliability. Additionally, 802.11be will introduce 4096-QAM (Quadrature Amplitude Modulation), enabling higher data rates by encoding more bits per symbol. The standard will also feature improved medium access control (MAC) efficiency, enhanced power saving capabilities, and better support for high-density environments. With these advancements, 802.11be is expected to deliver theoretical maximum data rates of up to 46 gigabits per second (Gbps), making it suitable for bandwidth-intensive applications such as virtual and augmented reality, 8K video streaming, and high-performance gaming. The IEEE 802.11be standard is projected to be finalized by the end of 2024, paving the way for the next generation of Wi-Fi devices and networks.

A distributed tone resource unit (dRU) is a resource unit that is composed of non-contiguous tones that are distributed across a spectrum. This is in contrast to a regular non-distributed tone resource unit (rRU) that is composed of contiguous tones. The use of dRU can improve spectral efficiency by enabling wireless devices to transmit using higher transmit power.

A dRU tone plan for a distribution bandwidth may specify the dRUs that are available in the distribution bandwidth and the data tones assigned to each of those dRUs. The dRU tone plan may also specify the pilot tone locations. Data tones are frequency resources for carrying data signals and pilot tones are frequency resources for carrying pilot signals. Pilot tones may be used for phase tracking to increase system performance. The distribution bandwidth may be the bandwidth across which dRU tones are distributed.

An existing approach for designing a dRU tone plan is to apply a dRU scheme to a rRU tone plan that distributes the tones from the rRUs specified by the corresponding rRU tone plan in a round-robin manner. For example, if the rRU tone plan specifies four rRUs, the dRU tone plan may be designed by assigning the first tone of the first rRU to be located at the first subcarrier index, assigning the first tone of the second rRU to be located at the second subcarrier index, assigning the first tone of the third rRU to be located at the third subcarrier index, assigning the first tone of the fourth rRU to be located at the fourth subcarrier index, assigning the second tone of the first rRU to be located at the fifth subcarrier index, assigning the second tone of the second rRU to be located at the sixth subcarrier index, assigning the second tone of the third rRU to be located at the seventh subcarrier index, assigning the second tone of the fourth rRU to be located at the seventh subcarrier index, and so on. However, this design approach results in the pilot tones being clustered into local areas (i.e., a group of pilot tones are located adjacent to each other). When pilot tones are clustered into local areas, phase tracking can become less accurate, which can result in the degradation of system performance.

### BRIEF DESCRIPTION OF THE DRAWINGS

The disclosure will be more fully understood from the detailed description provided below and the accompanying drawings that depict various embodiments of the disclosure. However, these drawings should not be interpreted as limiting the disclosure to the specific embodiments shown; they are provided for explanation and understanding only.

FIG. 1 illustrates an example of a wireless local area network (WLAN) with a basic service set (BSS) that includes multiple wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates interframe space (IFS) relationships, in accordance with some embodiments of the present disclosure.

FIG. 5 illustrates a Carrier Sense Multiple Access with Collision Avoidance (CSMA/CA)-based frame transmission procedure, in accordance with some embodiments of the present disclosure.

FIG. 6 illustrates maximum physical layer (PHY) rates for Institute of Electrical and Electronics Engineers (IEEE) 802.11 standards, in accordance with some embodiments of the present disclosure.

FIG. 7 provides a detailed description of fields in Extremely High Throughput (EHT) Physical Protocol Data Unit (PPDU) frames, including their purposes and characteristics, in accordance with some embodiments of the present disclosure.

FIG. 8 illustrates an example of multi-user (MU) transmission in Orthogonal Frequency-Division Multiple Access (OFDMA), in accordance with some embodiments of the present disclosure.

FIG. 9 illustrates an example of an access point sending a trigger frame to multiple associated stations and receiving Uplink Orthogonal Frequency-Division Multiple Access Trigger-Based Physical Protocol Data Units (UL OFDMA TB PPDUs) in response, in accordance with some embodiments of the present disclosure.

FIG. 10 is a diagram showing a regular non-distributed tone resource unit (rRU) tone plan for a 20 MHz bandwidth, according to some embodiments.

FIG. 11 is a diagram showing a distributed tone resource unit (dRU) tone plan for a 20 MHz bandwidth, according to some embodiments.

FIG. 12 is a diagram showing how a dRU tone plan can be designed based on a rRU tone plan, according to some embodiments.

FIG. 13 is a diagram showing a dRU tone plan for a 20 Megahertz (MHz) bandwidth that is designed by applying a dRU scheme to a rRU tone plan for a 20 MHz bandwidth that keeps the same number and locations of pilot tones as the rRU tone plan for a 20 MHz bandwidth while distributing the data tones of the rRUs across the distribution bandwidth at locations that are not occupied by the pilot tones, according to some embodiments.

FIG. 14 is a flow diagram of a method for receiving uplink trigger-based physical layer protocol data units (PPDUs) from stations (STAs) in accordance with a dRU tone plan for a distribution bandwidth, according to some embodiments.

FIG. 15 is a flow diagram of a method for transmitting an uplink trigger-based PPDU to an access point (AP) in accordance with a dRU tone plan for a distribution bandwidth, according to some embodiments.

### DETAILED DESCRIPTION

The present disclosure generally relates to wireless communications, and more specifically, relates to the pilot tone structure in a distributed tone resource unit (dRU) tone plan.

The use of dRU can improve spectral efficiency by enabling wireless devices to transmit using higher transmit power. When using dRUs, the design of the dRU tone plan may affect system performance. As mentioned above, an existing approach for designing a dRU tone plan is to apply a dRU scheme to a rRU tone plan that distributes the tones from the rRUs specified by the rRU tone plan in a round-robin manner. For example, if the rRU tone plan specifies four rRUs, the dRU tone plan may be designed by assigning the first tone of the first rRU to be located at the first subcarrier index, assigning the first tone of the second rRU to be located at the second subcarrier index, assigning the first tone of the third rRU to be located at the third subcarrier index, assigning the first tone of the fourth rRU to be located at the fourth subcarrier index, assigning the second tone of the first rRU to be located at the fifth subcarrier index, assigning the second tone of the second rRU to be located at the sixth subcarrier index, assigning the second tone of the third rRU to be located at the seventh subcarrier index, assigning the second tone of the fourth rRU to be located at the seventh subcarrier index, and so on. In this way, the tones of the rRUs can be distributed across the spectrum to create dRUs. However, this design approach results in the pilot tones being clustered into N local areas (i.e., a group of pilot tones are located adjacent to each other), where N is the number of pilot tones included in each rRU specified by the rRU tone plan. Clustered pilot tones are less robust to interference and spur. Thus, when pilot tones are clustered into local areas, phase tracking can become less accurate, which can result in the degradation of system performance. Ideally, pilot tones should be sufficiently separated to achieve frequency diversity.

The present disclosure introduces a new dRU tone plan design in which pilot tones are not clustered together but are distributed across a distribution bandwidth. The new dRU tone plan may specify the same number and location of pilot tones as the corresponding rRU tone plan (the rRU tone plan for the same bandwidth size). The new dRU tone plan may also specify dRUs having data tones that are distributed across the distribution bandwidth at locations (subcarrier indices) that are unoccupied by the pilot tones. With the new dRU tone plan design, pilot tones are distributed across the distribution bandwidth, which allows for more frequency diversity and improved phase tracking. At the same time, data tones of dRUs are distributed across the distribution bandwidth, which allows the transmitting device to transmit with higher transmit power. Since the new dRU tone plan keeps the same number and locations of pilot tones as the corresponding rRU tone plan, it may be backwards compatible, which allows for simpler implementation. The new dRU tone plan may allow the receiving device to use more pilot tones (pilot tones across the entire distribution bandwidth (even pilot tones of dRUs not assigned to the STA)), which may improve system performance.

According to some embodiments, an access point (AP) may assign dRUs to STAs in a distribution bandwidth. The dRU tone plan for the distribution bandwidth may specify a set of non-contiguous data tones within the distribution bandwidth for each dRU. The dRU tone plan for the distribution bandwidth may further specify pilot tones that are located at the same subcarrier indices as pilot tones specified by a regular non-distributed tone resource unit (rRU) tone plan for the distribution bandwidth. The AP may then solicit uplink trigger-based physical layer protocol data units (PPDUs) from the STAs in accordance with the assignment of the dRUs. The AP may solicit the uplink trigger-based PPDUs from the STAs by transmitting a trigger frame to the STAs. The trigger frame may include an indication of which dRUs are assigned to which of the STAs. Responsive to receiving the trigger frame, each STA may transmit an uplink trigger-based PPDU to the AP in the dRU assigned to the STA in accordance with the dRU tone plan for the distribution bandwidth. Transmitting the uplink trigger-based PPDU in accordance with the dRU tone plan for the distribution bandwidth may involve transmitting data signals in a set of non-contiguous data tones assigned to the dRU assigned to the transmitting STA and transmitting pilot signals in a set of pilot tones assigned to the dRU assigned to the transmitting STA in accordance with the dRU tone plan for the distribution bandwidth. The AP may receive uplink trigger-based PPDUs from the STAs in the dRUs assigned to the STAs in accordance with the dRU tone plan for the distribution bandwidth. Receiving the uplink trigger-based PPDUs from the STAs in accordance with the dRU tone plan for the distribution bandwidth may involve interpreting certain tones as being data tones and interpreting other tones as being pilot tones in accordance with the dRU tone plan for the distribution bandwidth.

For purposes of illustration, various embodiments are described herein in the context of wireless networks that are based on IEEE 802.11 standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in different ways, all without departing from the spirit or scope of the present invention. Accordingly, the drawings and description are to be regarded as illustrative in nature and not restrictive. Like reference numerals designate like elements throughout the specification.

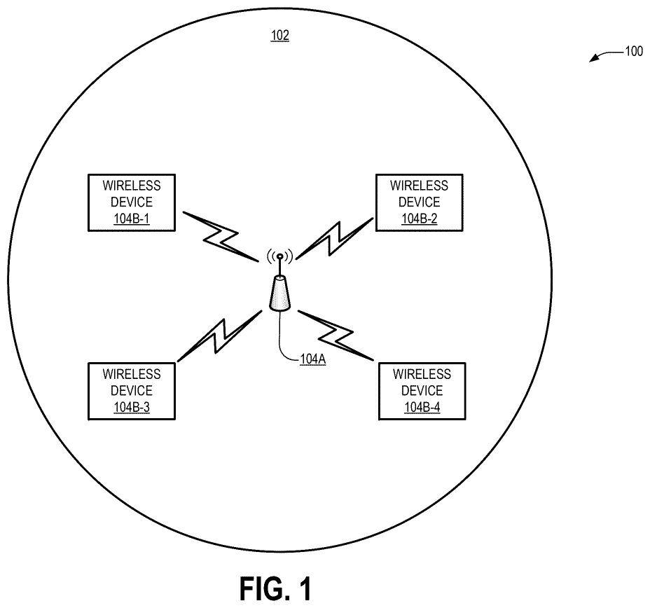

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B1-104B4 that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B1-104B4) may be collectively referred to as STAs. However, for ease of description, only the non-AP STAs may be referred to as STAs unless the context indicates otherwise. Although shown with four non-AP STAs (e.g., the wireless devices 104B1-104B4), the WLAN 100 may include any number of non-AP STAs (e.g., one or more wireless devices 104B).

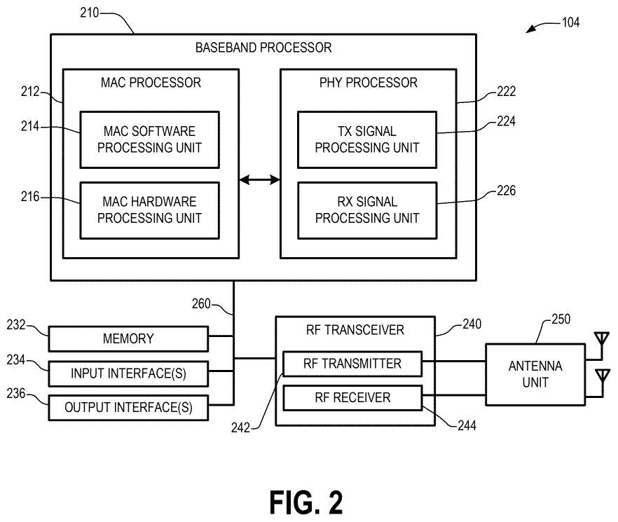

FIG. 2 illustrates a schematic block diagram of a wireless device 104, according to an embodiment. The wireless device 104 may be the wireless device 104A (i.e., the AP of the WLAN 100) or any of the wireless devices 104B1-104B4 in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

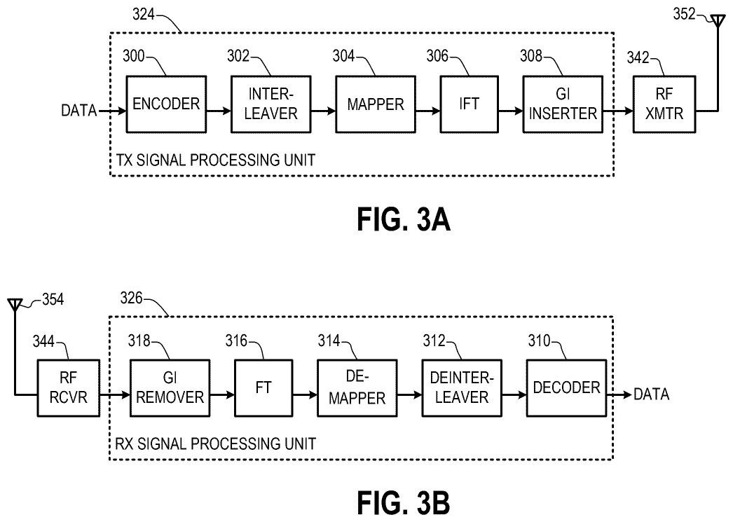

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of 0 s or 1 s. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) (also referred to as PLCP (Physical Layer Convergence Procedure) Protocol Data Units) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

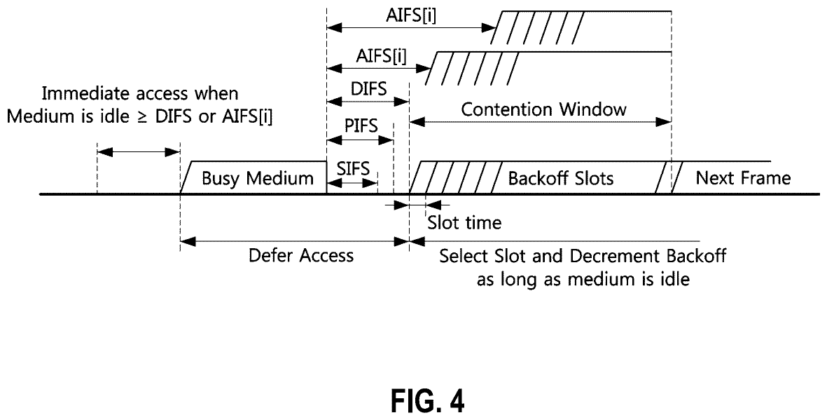

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS[i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QoS) functionality (that is, a QoS STA) may transmit the frame after performing backoff if an AIFS for an associated access category (AC) (i.e., AIFS[AC]) has elapsed. When transmitted by the QoS STA, any of the data frame, the management frame, and the control frame, which is not the response frame, may use the AIFS[AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

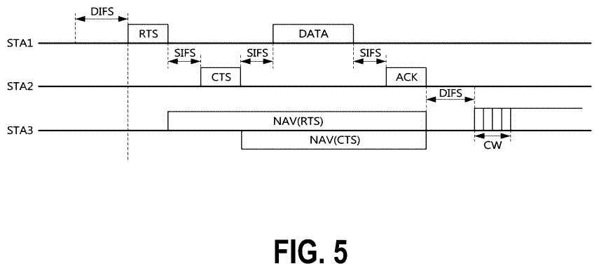

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

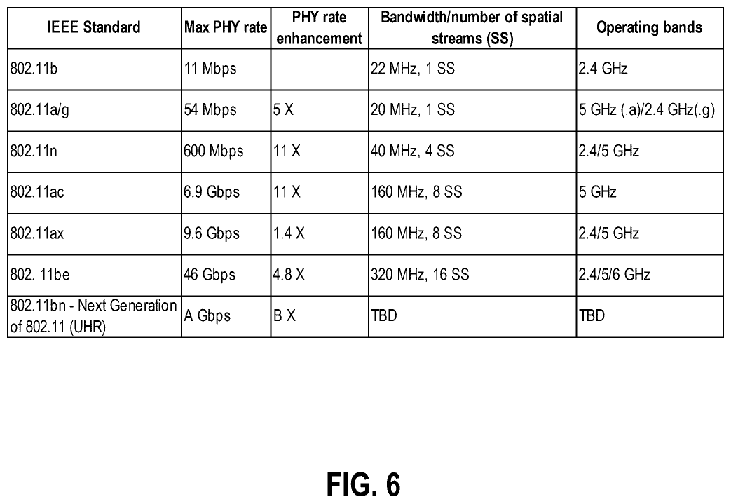

The IEEE 802.11bn (Ultra High Reliability, UHR) working group has been established to address the growing demand for higher peak throughput and reliability in Wi-Fi. As shown in FIG. 6, the peak PHY rate has significantly increased from IEEE 802.11b to IEEE 802.11be (Wi-Fi 7), with the latter focusing on further improving peak throughput. The UHR study group aims to enhance the tail of the latency distribution and jitter to support applications that require low latency, such as video-over-WLAN, gaming, AR, and VR. It is noted that various characteristics of UHR (e.g., max PHY rate, PHY rate enhancement, bandwidth/number of spatial streams, and operating bands) are still to be determined.

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320 MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

The focus of IEEE 802.11bn (UHR) is still under discussion, with candidate features including MLO enhancements (e.g., in terms of increased throughput/reliability and decreased latency), latency and reliability improvements (e.g., multi-AP coordination to support low latency traffic), bandwidth expansion (e.g., to 240, 480, 640 MHz), aggregated PPDU (A-PPDU), enhanced multi-link single-radio (eMLSR) extensions to AP, roaming improvements, and power-saving schemes for prolonging battery life.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHz) for IEEE 802.11be, more than 1 GHz of additional unlicensed spectrum is likely to be available because the 6 GHz band (5.925-7.125 GHz) is being considered for unlicensed use. This would allow APs and STAs to become tri-band devices. Larger than 160 MHz data transmissions (e.g., 320 MHz or 640 MHz) could be considered to increase the maximum PHY rate. For example, 320 MHz or 160+160 MHz data could be transmitted in the 6 GHz band. For example, 160+160 MHz data could be transmitted across the 5 and 6 GHz bands.

In the process of wireless communication, a transmitting station (STA) creates a Physical Layer Protocol Data Unit (PPDU) frame and sends it to a receiving STA. The receiving STA then receives, detects, and processes the PPDU.

The Extremely High Throughput (EHT) PPDU frame encompasses several components. It includes a legacy part, which comprises fields such as the Legacy Short Training Field (L-STF), Legacy Long Training Field (L-LTF), Legacy Signal Field (L-SIG), and Repeated Legacy Signal Field (RL-SIG). These fields are used to maintain compatibility with older Wi-Fi standards.

In addition to the legacy part, the EHT PPDU frame also contains the Universal Signal Field (U-SIG), EHT Signal Field (EHT-SIG), EHT Short Training Field (EHT-STF), and EHT Long Training Field (EHT-LTF). These fields are specific to the EHT standard and are used for various purposes, such as signaling, synchronization, and channel estimation.

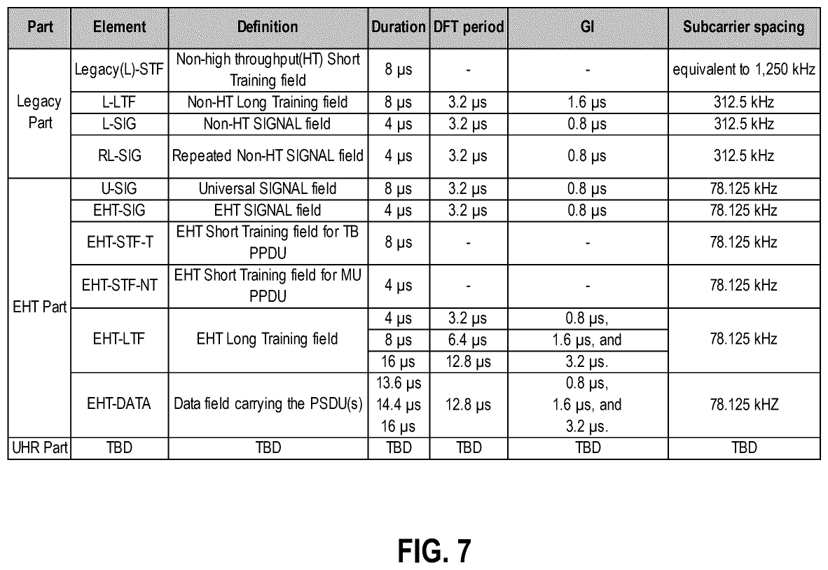

FIG. 7 provides a more detailed description of each field in the EHT PPDU frame, including their purposes and characteristics.

Regarding the Ultra High Reliability (UHR) PPDU, its frame structure is currently undefined and will be determined through further discussions within the relevant working group or study group. This indicates that the specifics of the UHR PPDU are still under development and will be finalized based on the outcomes of future deliberations.

The distributed nature of channel access networks, such as IEEE 802.11 WLANs, makes the carrier sense mechanism useful for ensuring collision-free operation. Each station (STA) uses its physical carrier sense to detect transmissions from other STAs. However, in certain situations, it may not be possible for a STA to detect every transmission. For instance, when one STA is located far away from another STA, it might perceive the medium as idle and start transmitting a frame, leading to collisions. To mitigate this hidden node problem, the network allocation vector (NAV) has been introduced.

As the IEEE 802.11 standard continues to evolve, it now includes scenarios where multiple users can simultaneously transmit or receive data within a basic service set (BSS), such as uplink (UL) and downlink (DL) multi-user (MU) transmissions in a cascaded manner. In these cases, the existing carrier sense and NAV mechanisms may not be sufficient, and modifications or newly defined mechanisms may be required to facilitate efficient and collision-free operation.

For the purpose of this disclosure, MU transmission refers to situations where multiple frames are transmitted to or from multiple STAs simultaneously using different resources. Examples of these resources include different frequency resources in Orthogonal Frequency Division Multiple Access (OFDMA) transmission and different spatial streams in Multi-User Multiple Input Multiple Output (MU-MIMO) transmission. Consequently, downlink OFDMA (DL-OFDMA), downlink MU-MIMO (DL-MU-MIMO), uplink OFDMA (UL-OFDMA), uplink MU-MIMO (UL-MU-MIMO), and OFDMA with MU-MIMO are all considered examples of MU transmission.

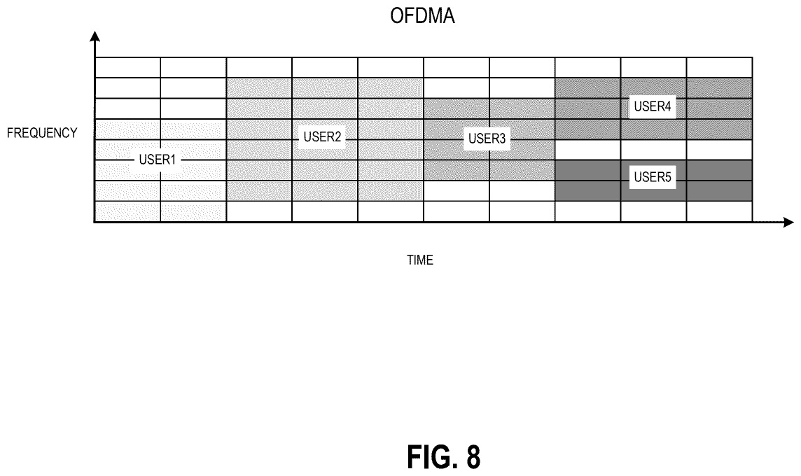

FIG. 8 illustrates an example of multi-user (MU) transmission in Orthogonal Frequency-Division Multiple Access (OFDMA), in accordance with some embodiments of the present disclosure.

In the IEEE 802.11ax and 802.11be specifications, the trigger frame plays a useful role in facilitating uplink multi-user (MU) transmissions. The purpose of the trigger frame is to allocate resources and solicit one or more Trigger-based (TB) Physical Layer Protocol Data Unit (PPDU) transmissions from the associated stations (STAs).

The trigger frame contains information required by the responding STAs to send their Uplink TB PPDUs. This information includes the Trigger type, which specifies the type of TB PPDU expected, and the Uplink Length (UL Length), which indicates the duration of the uplink transmission.

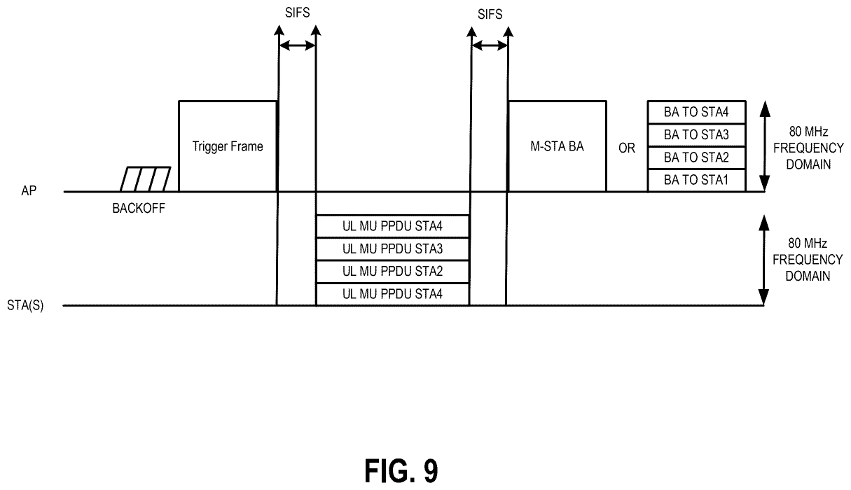

FIG. 9 illustrates an example scenario where an access point (AP) operating in an 80 MHz bandwidth environment sends a Trigger frame to multiple associated STAs. Upon receiving the Trigger frame, the STAs respond by sending their respective Uplink Orthogonal Frequency Division Multiple Access (UL OFDMA) TB PPDUs, utilizing the allocated resources within the specified 80 MHz bandwidth.

After successfully receiving the UL OFDMA TB PPDUs, the AP acknowledges the STAs by sending an acknowledgement frame. This acknowledgement can be in the form of an 80 MHz width multi-STA Block Acknowledgement (Block Ack) or a Block Acknowledgement with a Direct Feedback (DF) OFDMA method. The multi-STA Block Ack allows the AP to acknowledge multiple STAs simultaneously, while the Block Ack with DF OFDMA enables the AP to provide feedback to the STAs using the same OFDMA technique employed in the uplink transmission.

The trigger frame is a useful component in enabling efficient uplink MU transmissions in IEEE 802.11ax and 802.11be networks, by allocating resources and coordinating the uplink transmissions from multiple STAs within the same bandwidth.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

AP coordination has been considered as a potential technology to improve WLAN system throughput in the IEEE 802.11be standard and is still being discussed in the IEEE 802.11bn (UHR) standard. To support various AP coordination schemes, such as coordinated beamforming, OFDMA, TDMA, spatial reuse, and joint transmission, a predefined mechanism for APs is necessary.

In the context of coordinated TDMA (C-TDMA), the AP that obtains a transmit opportunity (TXOP) is referred to as the sharing AP. This AP initiates the AP coordination schemes to determine the AP candidate set by sending a frame, such as a Beacon frame or probe response frame, which includes information about the AP coordination scheme capabilities. The AP that participates in the AP coordination schemes after receiving the frame from the sharing AP is called the shared AP. The sharing AP is also known as the master AP or coordinating AP, while the shared AP is referred to as the slave AP or coordinated AP.

The operation of various AP coordination schemes has been discussed in the IEEE 802.11be and UHR standards:

Coordinated Beamforming (C-BF): Multiple APs transmit on the same frequency resource by coordinating and forming spatial nulls, allowing for simultaneous transmission from multiple APs.

Coordinated OFDMA (C-OFDMA): APs transmit on orthogonal frequency resources by coordinating and splitting the spectrum, enabling more efficient spectrum utilization.

Joint Transmission (JTX): Multiple APs transmit jointly to a given user simultaneously by sharing data between the APs.

Coordinated Spatial Reuse (C-SR): Multiple APs or STAs adjust their transmit power to reduce interference between APs.

By implementing these AP coordination schemes, WLAN systems can improve their overall throughput and efficiency by leveraging the cooperation between multiple APs.

Distributed tone resource unit (dRU) is a physical (PHY) layer feature that can help improve spectral efficiency. The use of dRUs may help with overcoming the power spectral density (PSD) limitation. Various power modes are defined in 6 GHz bands such as standard power (SP) mode, very low power (VLP) mode, and low power indoor (LPI) mode. The PSD limitation is stringent especially in VLP mode and LPI mode in 6 GHz bands and especially for non-AP STAs. For example, the PSD limitation of a non-AP STA in LPI mode is −1 dBM/MHz. As a result, using many RU tones in a limited bandwidth can decrease transmit power due to the stringent PSD limitation.

The use of dRU can overcome this limitation by distributing tones within a distribution bandwidth. To allow dRU to coexist with rRU (a rRU may be a basic RU or multiple RUs), a dRU tone plan can be designed based on applying a dRU scheme to a conventional rRU tone plan.

An example of a rRU tone plan is first described to provide helpful context.

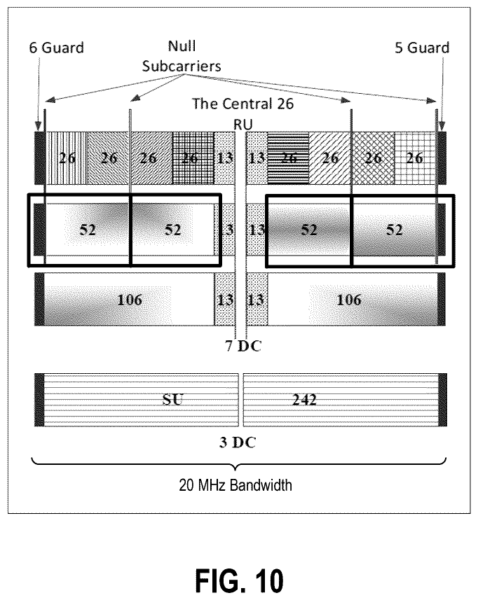

FIG. 10 is a diagram showing a rRU tone plan for a 20 MHz bandwidth, according to some embodiments.

As highlighted in the diagram, the rRU tone plan for a 20 MHz bandwidth may specify four 52-tone rRUs. Each 52-tone rRU may be assigned a set of contiguous tones. For example, the first 52-tone rRU may be assigned tones located at subcarrier indices [−121:70], the second 52-tone rRU may be assigned tones located at subcarrier indices [−68:−17], the third 52-tone rRU may be assigned tones located at subcarrier indices [17:68], and the fourth 52-tone rRU may be assigned tones located at subcarrier indices [70:121]. The notation [X:Y] indicates the interval from X to Y inclusive of the endpoints.

With such a rRU tone plan, an AP operating in a 20 MHz bandwidth may assign four 52-tone rRUs to four different STAs (STA1, STA2, STA3, and STA4) and solicit uplink trigger-based PPDUs from those STAs. Responsive to the solicitation, the STAs may transmit their respective uplink trigger-based PPDUs in their assigned 52-tone rRUs in accordance with the rRU tone plan.

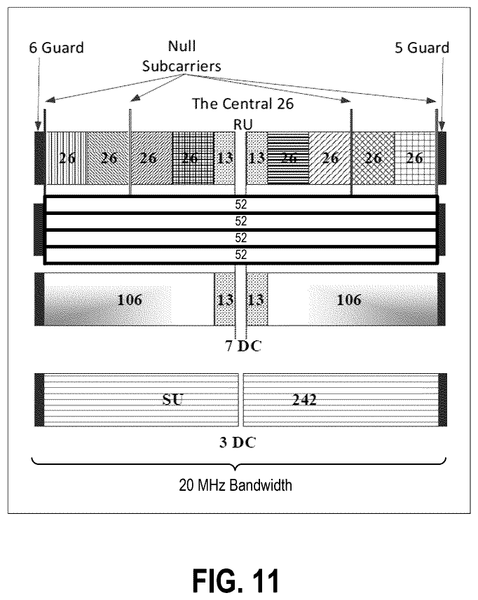

FIG. 11 is a diagram showing a dRU tone plan for a 20 MHz bandwidth, according to some embodiments.

As highlighted in the diagram, the dRU tone plan for a 20 MHz bandwidth may specify four 52-tone dRUs. Each 52-tone dRU may be assigned a set of non-contiguous tones that are distributed across the 20 MHz bandwidth.

With such a dRU tone plan, an AP operating in a 20 MHz bandwidth may assign four 52-tone dRUs to four different STAs (STA1, STA2, STA3, and STA4) and solicit uplink trigger-based PPDUs from those STAs. Responsive to the solicitation, the STAs may transmit their respective uplink trigger-based PPDUs in their assigned 52-tone dRUs in accordance with the dRU tone plan. Since the tones included in the dRUs are distributed across the distribution bandwidth (20 MHz bandwidth in this example), the trigger-based PPDUs may be transmitted using higher transmit power (compared to when the PPDUs are transmitted in rRUs).

A dRU tone plan may be designed by applying a dRU scheme to a rRU tone plan.

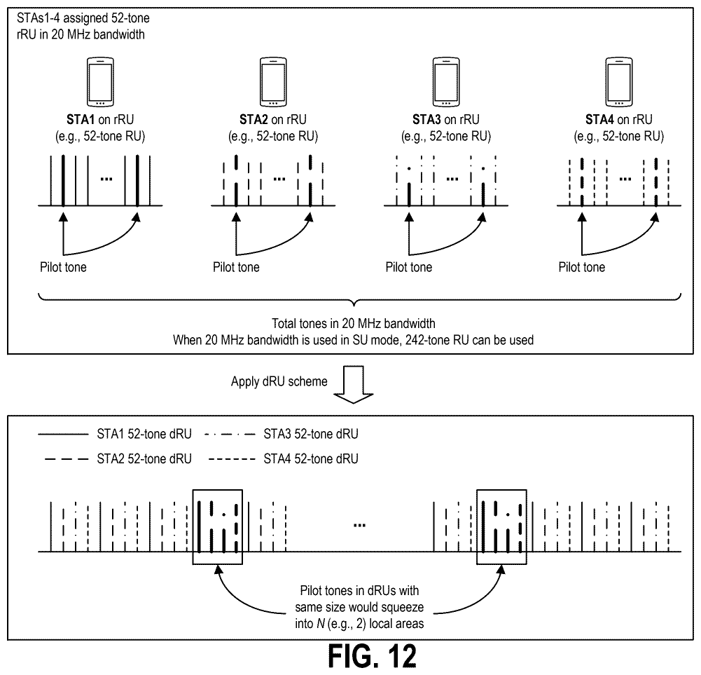

FIG. 12 is a diagram showing how a dRU tone plan can be designed based on a rRU tone plan, according to some embodiments.

As shown in the diagram, four STAs (STA1, STA2, STA3, and STA4) may be assigned to different rRUs (e.g., 52-tone rRUs) within a 20 MHz bandwidth in accordance with a rRU tone plan for the 20 MHz bandwidth (e.g., the rRU tone plan shown in FIG. 10). Each of the rRUs may include a set of contiguous tones, which may include data tones and pilot tones. In the diagram, data tones are depicted using non-bolded lines and pilot tones are depicted using bolded lines. All of the rRUs may include pilot tones at the same relative locations/subcarrier indices. For example, in the example shown in the diagram, each rRU includes a pilot tone in the second subcarrier index for the rRU and the second to last subcarrier index for the rRU. For purposes of explanation only, it is assumed that each rRU includes two pilot tones. It should be appreciated, however, that each rRU can include more than two pilot tones. Indeed, a 52-tone rRU will typically include four pilot tones. However, it is assumed in this example that each rRU includes two pilot tones to simplify explanation.

As shown in the diagram, a dRU tone plan can be designed by applying a dRU scheme to the rRU tone plan that distributes the tones from the rRUs specified by the rRU tone plan in a round-robin manner. For example, as shown in the diagram, a dRU tone plan for the 20 MHz bandwidth may be designed by assigning the first tone of the first rRU (the rRU assigned to STA1) to be located at the first subcarrier index, assigning the first tone of the second rRU (the rRU assigned to STA2) to be located at the second subcarrier index, assigning the first tone of the third rRU (the rRU assigned to STA3) to be located at the third subcarrier index, assigning the first tone of the fourth rRU (the rRU assigned to STA4) to be located at the fourth subcarrier index, assigning the second tone of the first rRU to be located at the fifth subcarrier index, assigning the second tone of the second rRU to be located at the sixth subcarrier index, assigning the second tone of the third rRU to be located at the seventh subcarrier index, assigning the second tone of the fourth rRU to be located at the eighth subcarrier index, and so on.

With such a dRU tone plan design, it can be seen that the pilot tones are clustered into N local areas, where N is the number of pilot tones included in each rRU. Clustered pilot tones are less robust to interference and spur. Thus, when pilot tones are clustered into local areas, phase tracking can become less accurate, which can result in the degradation of system performance. Ideally, pilot tones should be sufficiently separated to achieve frequency diversity.

To address this problem, a new dRU tone plan design is introduced herein in which pilot tones are not clustered together but are distributed across a distribution bandwidth. The new dRU tone plan may specify the same number and locations of pilot tones as the corresponding rRU tone plan. The new dRU tone plan may also specify dRUs having data tones that are distributed across the distribution bandwidth at locations (subcarrier indices) that are unoccupied by the pilot tones. The new dRU tone plan may be designed by applying a dRU scheme to a rRU tone plan that keeps the same number and locations of pilot tones as the rRU tone plan while distributing the data tones of the rRUs specified by the rRU tone plan across the distribution bandwidth at locations (subcarrier indices) that are not occupied by the pilot tones in a round-robin manner.

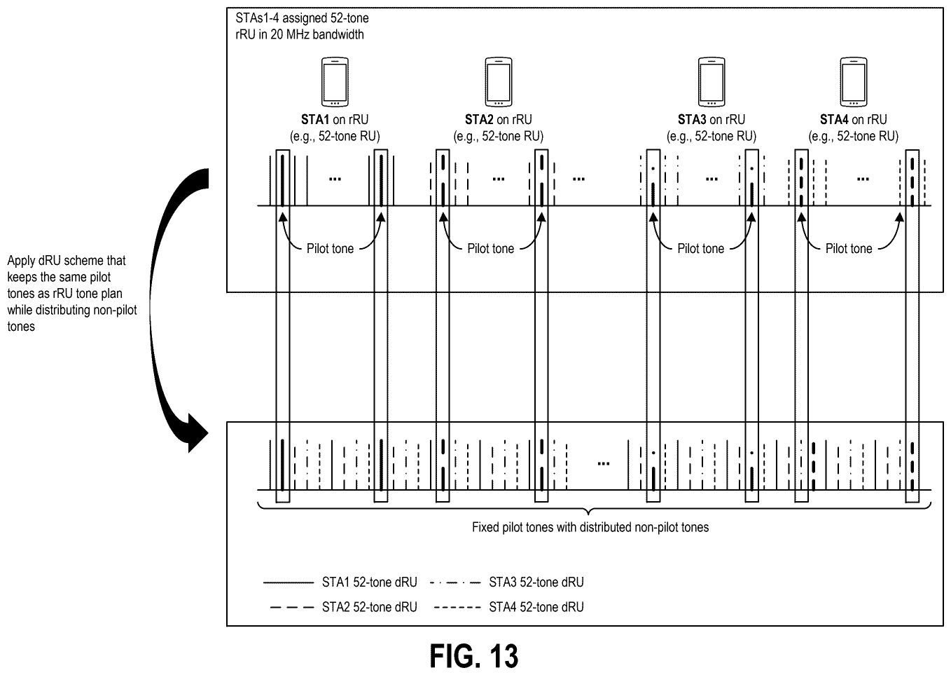

FIG. 13 is a diagram showing a dRU tone plan for a 20 MHz bandwidth that is designed by applying a dRU scheme to a rRU tone plan for a 20 MHz bandwidth that keeps the same number and locations of pilot tones as the rRU tone plan for a 20 MHz bandwidth while distributing the data tones of the rRUs across the distribution bandwidth at locations that are not occupied by the pilot tones, according to some embodiments.

As shown in the diagram, a dRU tone plan for a 20 MHz bandwidth can be designed by applying a dRU scheme to the rRU tone plan for the 20 MHz bandwidth that keeps the same number and locations of pilot tones as the rRU tone plan while distributing data tones of the rRUs specified by the rRU tone plan across the 20 MHz bandwidth at locations (subcarrier indices) that are not occupied by the pilot tones. For example, as shown in the diagram, the two pilot tones included in the first 52-tone rRU (assigned to STA1), the two pilot tones included in the second 52-tone rRU (assigned to STA1), the two pilot tones included in the third 52-tone rRU (assigned to STA3), and the two pilot tones included in the fourth 52-tone rRU (assigned to STA4) retain their locations in the dRU tone plan. However, the data tones of these rRUs may be distributed across the 20 MHz bandwidth by assigning the data tones of the rRUs to the next available location (subcarrier index) that is not occupied by a pilot tone in a round-robin manner. Thus, the dRU tone plan may keep the same pilot tones as the corresponding rRU tone plan while distributing the data tones of the rRUs across the 20 MHz bandwidth to create dRUs.

In an embodiment, both the rRU tone plan for a 20 MHz bandwidth and the dRU tone plan for the 20 MHz bandwidth specifies pilot tones as being located at subcarrier indices −116, −102, −90, −76, −62, −48, −36, −22, 22, 36, 48, 62, 76, 90, 102, and 116 when 52-tone RUs are used. However, the dRU tone plan specifies dRUs having data tones that are distributed across the 20 MHz bandwidth. For example, the tones of a given dRU (e.g., 52-tone dRU) may be assigned tones located at subcarrier indices −120, −116 (pilot), −111, −107, −102 (pilot), −98, −93, −90 (pilot), −84, −80, −76 (pilot), −71, −66, −62, −57, −53, −48, −44, −39, −35, −30, −26, −21, −17, −12, −8, 6, 10, 15, 19, 24, 28, 33, 37, 42, 46, 51, 55, 60, 64, 69, 73, 78, 82, 87, 91, 96, 100, 105, 109, 114, and 118. Of these tones the tones located at subcarrier indices −116, −102, −90, and −76 may be pilot tones and the other tones may be non-pilot (e.g., data) tones.

While the diagram shows a particular a particular dRU tone plan design, it should be noted that the design is shown to illustrate a specific example of the general concepts described herein. Embodiments are not limited to this particular dRU tone plan design. One having ordinary skill in the relevant art will recognize that a dRU tone plan can be designed differently from what is shown in the diagram without departing from the spirit and scope of the present disclosure. Also, for purposes of illustration only, the diagram shows an example of a dRU tone plan for a 20 MHz bandwidth with 52-tone dRUs. One having ordinary skill in the relevant art will recognize that dRU tone plans for other distribution bandwidths and/or other dRU sizes can be designed in accordance with the concepts described herein.

Uplink and downlink transmissions may be improved by using the new dRU tone plan design.

For example, for uplink transmission, if the AP operates in a 160 MHz bandwidth (the operating bandwidth is 160 MHz), the AP may assign rRUs within a first 80 MHz bandwidth to a first set of STAs in accordance with a rRU tone plan for a 80 MHz bandwidth and may assign dRUs within a second 80 MHz bandwidth to a second set of STAs in accordance with a dRU tone plan for a 80 MHz bandwidth. The AP may then solicit uplink trigger-based PPDUs from the first set of STAs and the second set of STAs in accordance with the assignment. This may be considered as a hybrid mode of operation in which rRUs and dRUs can coexist. The AP may assign the first set of STAs to rRUs because those STAs cannot interpret the dRU tone plan (e.g., they are legacy STAs) or because those STAs have no need to use dRUs. Since the new dRU tone plan keeps the pilot tones fixed (to be the same as the rRU tone plan defined in the existing wireless networking standard), the hybrid mode of operation can be implemented without having to introduce new signaling/operations for indicating the pilot tone locations in the first 80 MHz bandwidth and the second 80 MHz bandwidth, which reduces the implementation complexity. The pilot tone structure of the new dRU tone plan is thus designed considering backwards compatibility.

Also, since the AP already knows the pilot tone locations within the distribution bandwidth, it can use more pilot tones when receiving PPDUs in dRUs, which may result in increased system performance. For example, in the example shown in FIG. 13, when the AP assigns a 52-tone rRU to STA1, the AP can only use two pilot tones (e.g., for phase tracking) when receiving an uplink trigger-based PPDU from STA1. However, by using the new dRU tone plan described herein, when the AP assigns a 52-tone dRU to STA1, it can use eight pilot tones (the pilot tones for all of the dRUs) when receiving an uplink trigger-based PPDU from STA1. Using more pilot tones can help with performing carrier frequency offset (CFO) compensation.

For downlink transmission, if it is assumed that the AP and STAs operate in a 80 MHz bandwidth, the AP may transmit a 80 MHz downlink PPDU to the STAs in dRUs in accordance with the dRU tone plan. Since the STAs already know the number and locations of the pilot tones within the 80 MHz distribution bandwidth, they can use multiple pilot tones (e.g., for phase tracking) when receiving the downlink PPDU, which may result in improved performance. For example, a STA may use pilot tones of dRUs not assigned to the STA when receiving the downlink PPDU for better phase tracking.

More generally, by using the new dRU tone plan introduced herein, the receiving device may use more pilot tones without any extra signaling/operation, which can improve the overall system performance.

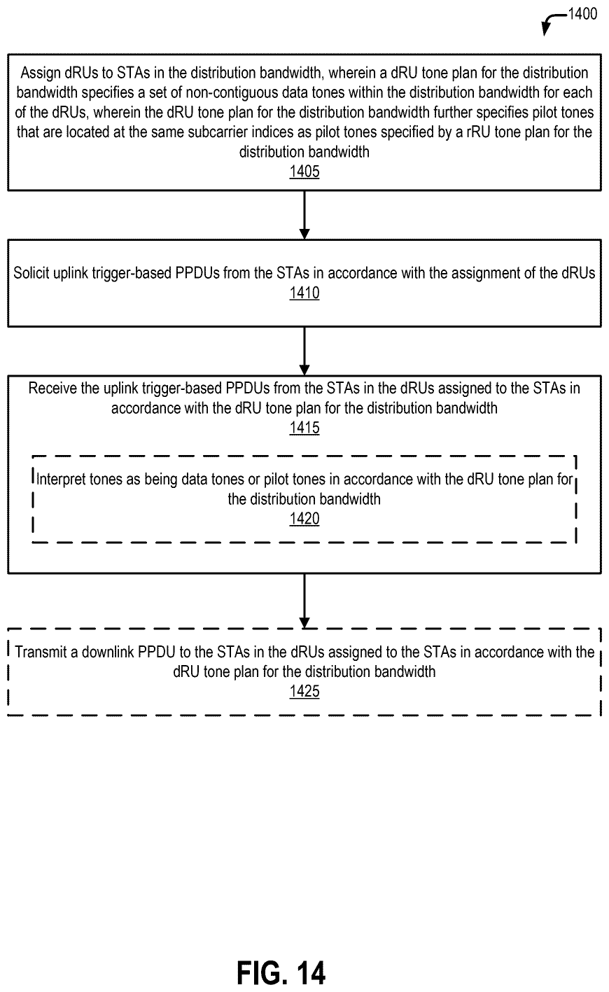

Turning now to FIG. 14, a method 1400 will be described for receiving uplink trigger-based PPDUs from STAs in accordance with a dRU tone plan for a distribution bandwidth, in accordance with an example embodiment. The method 1400 may be performed by an AP. The AP may be implemented by a wireless device (e.g., wireless device 104).

Additionally, although shown in a particular order, in some embodiments the operations of the method 1400 (and the other methods shown in the other figures) may be performed in a different order. For example, although the operations of the method 1400 are shown in a sequential order, some of the operations may be performed in partially or entirely overlapping time periods.

At operation 1405, the AP assigns dRUs to STAs in the distribution bandwidth, wherein a dRU tone plan for the distribution bandwidth specifies a set of non-contiguous data tones within the distribution bandwidth for each of the dRUs, wherein the dRU tone plan for the distribution bandwidth further specifies pilot tones that are located at the same subcarrier indices as pilot tones specified by a rRU tone plan for the distribution bandwidth. In an embodiment, the distribution bandwidth is a 20 MHz bandwidth and the dRUs are 52-tone dRUs. In such an embodiment, the pilot tones specified by the dRU tone plan for the distribution bandwidth may be located at subcarrier indices −116, −102, −90, −76, −62, −48, −36, −22, 22, 36, 48, 62, 76, 90, 102, and 116.

At operation 1410, the AP solicits uplink trigger-based PPDUs from the STAs in accordance with the assignment of the dRUs. For example, the AP may solicit the uplink trigger-based PPDUs from the STAs by transmitting a trigger frame to the STAs. The trigger frame may include an indication of which dRUs are assigned to which of the STAs.

At operation 1415, the AP receives the uplink trigger-based PPDUs from the STAs in the dRUs assigned to the STAs in accordance with the dRU tone plan for the distribution bandwidth. In an embodiment, the receiving of the uplink trigger-based PPDUs comprises operation 1420. At operation 1420, the AP interprets tones as being data tones or pilot tones in accordance with the dRU tone plan for the distribution bandwidth.

In an embodiment, at operation 1425, the AP transmits a downlink PPDU to the STAs in the dRUs assigned to the STAs in accordance with the dRU tone plan for the distribution bandwidth. In an embodiment, the transmission of the downlink PPDU comprises transmitting data signals in the data tones of the dRUs assigned to the STAs and transmitting pilot signals in the pilot tones of the dRU assigned to the STA in accordance with the dRU tone plan for the distribution bandwidth.

In an embodiment, the AP assigns rRUs to further STAs and solicits further uplink trigger-based PPDUs from the further STAs in accordance with the assignment of the rRUs. The AP may then receive the further uplink trigger-based PPDUs from the further STAs in the rRUs assigned to the further STAs in accordance with a rRU tone plan, wherein the uplink trigger-based PPDUs and the further uplink trigger-based PPDUs are received simultaneously (thus implementing a hybrid mode of operation where rRUs and dRUs coexist).

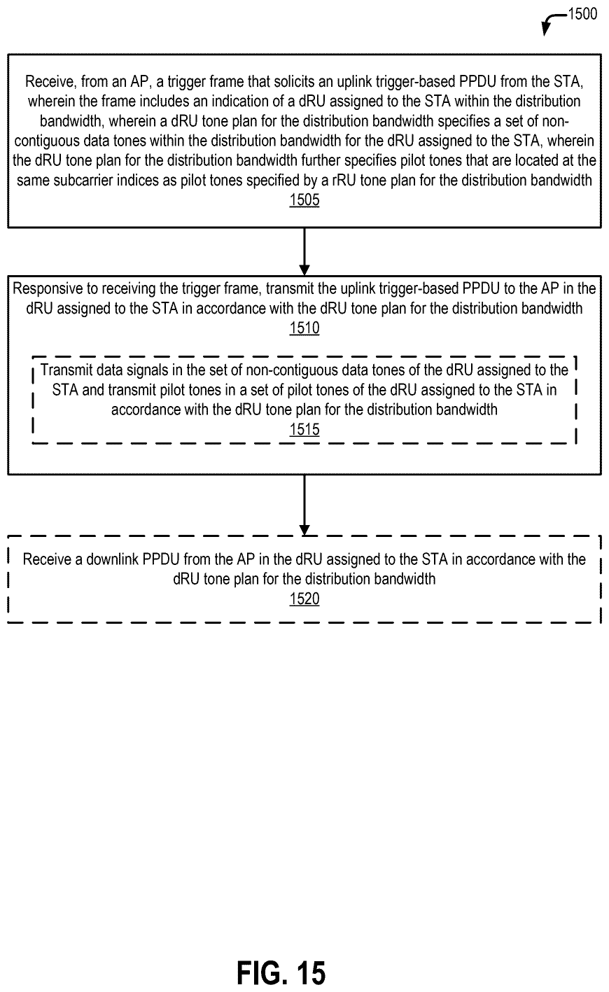

Turning now to FIG. 15, a method 1500 will be described for transmitting an uplink trigger-based PPDU to an AP in accordance with a dRU tone plan for a distribution bandwidth, in accordance with an example embodiment. The method 1500 may be performed by a STA. The STA may be implemented by a wireless device (e.g., wireless device 104).

At operation 1505, the STA receives, from an AP, a trigger frame that solicits an uplink trigger-based PPDU from the STA, wherein the frame includes an indication of a dRU assigned to the STA within the distribution bandwidth, wherein a dRU tone plan for the distribution bandwidth specifies a set of non-contiguous data tones within the distribution bandwidth for the dRU assigned to the STA, wherein the dRU tone plan for the distribution bandwidth further specifies pilot tones that are located at the same subcarrier indices as pilot tones specified by a rRU tone plan for the distribution bandwidth. In an embodiment, the distribution bandwidth is a 20 MHz bandwidth and the dRU assigned to the STA is a 52-tone dRU. In such an embodiment, the pilot tones specified by the dRU tone plan for the distribution bandwidth may be located at subcarrier indices −116, −102, −90, −76, −62, −48, −36, −22, 22, 36, 48, 62, 76, 90, 102, and 116.

At operation 1510, responsive to receiving the trigger frame, the STA transmits the uplink trigger-based PPDU to the AP in the dRU assigned to the STA in accordance with the dRU tone plan for the distribution bandwidth. In an embodiment, the transmitting of the uplink trigger-based PPDU to the AP comprises operation 1515. At operation 1515, the STA transmits data signals in the set of non-contiguous data tones of the dRU assigned to the STA and transmits pilot tones in a set of pilot tones of the dRU assigned to the STA in accordance with the dRU tone plan for the distribution bandwidth.

In an embodiment, at operation 1520, the STA receives a downlink PPDU from the AP in the dRU assigned to the STA in accordance with the dRU tone plan for the distribution bandwidth. In an embodiment, the receiving of the downlink PPDU comprises interpreting tones as being data tones or pilot tones in accordance with the dRU tone plan for the distribution bandwidth, wherein the STA uses pilot tones of dRUs not assigned to the STA (e.g., for phase tracking) when receiving the downlink PPDU.

In an embodiment, the trigger frame also solicits a further uplink trigger-based PPDU from a further STA that is assigned to a rRU, wherein the further STA transmits the further uplink trigger-based PPDU in the rRU assigned to the further STA in accordance with a rRU tone plan, wherein the uplink trigger-based PPDU and the further uplink trigger-based PPDU are transmitted simultaneously (thus implementing a hybrid mode of operation where rRUs and dRUs coexist).

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by an access point (AP) to receive uplink trigger-based physical layer protocol data units (PPDUs) from stations (STAs) in accordance with a distributed tone resource unit (dRU) tone plan for a distribution bandwidth, the method comprising:
assigning dRUs to the STAs in the distribution bandwidth, wherein the dRU tone plan for the distribution bandwidth specifies a set of non-contiguous data tones within the distribution bandwidth for each of the dRUs, wherein the dRU tone plan for the distribution bandwidth further specifies pilot tones that are located at the same subcarrier indices as pilot tones specified by a regular non-distributed tone resource unit (rRU) tone plan for the distribution bandwidth;
soliciting the uplink trigger-based PPDUs from the STAs in accordance with the assignment of the dRUs; and
receiving the uplink trigger-based PPDUs from the STAs in the dRUs assigned to the STAs in accordance with the dRU tone plan for the distribution bandwidth.

2. The method of claim 1, wherein the distribution bandwidth is a 20 Megahertz (MHz) bandwidth and the dRUs are 52-tone dRUs.

3. The method of claim 2, wherein the pilot tones specified by the dRU tone plan for the distribution bandwidth are located at subcarrier indices −116, −102, −90, −76, −62, −48, −36, −22, 22, 36, 48, 62, 76, 90, 102, and 116.

4. The method of claim 1, further comprising:
transmitting a downlink PPDU to the STAs in the dRUs assigned to the STAs in accordance with the dRU tone plan for the distribution bandwidth.

5. The method of claim 1, further comprising:
assigning rRUs to further STAs;
soliciting further uplink trigger-based PPDUs from the further STAs in accordance with the assignment of the rRUs; and
receiving the further uplink trigger-based PPDUs from the further STAs in the rRUs assigned to the further STAs in accordance with a rRU tone plan, wherein the uplink trigger-based PPDUs and the further uplink trigger-based PPDUs are received simultaneously.

6. The method of claim 1, wherein the receiving the uplink trigger-based PPDUs comprises interpreting tones as being data tones or pilot tones in accordance with the dRU tone plan for the distribution bandwidth.

7. A method performed by a station (STA) to transmit an uplink trigger-based physical layer protocol data unit (PPDU) to an access point (AP) in accordance with a distributed tone resource unit (dRU) tone plan for a distribution bandwidth, the method comprising:
receiving, from the access point (AP), a trigger frame that solicits the uplink trigger-based PPDU from the STA, wherein the frame includes an indication of a dRU assigned to the STA within the distribution bandwidth, wherein the dRU tone plan for the distribution bandwidth specifies a set of non-contiguous data tones within the distribution bandwidth for the dRU assigned to the STA, wherein the dRU tone plan for the distribution bandwidth further specifies pilot tones that are located at the same subcarrier indices as pilot tones specified by a regular non-distributed tone resource unit (rRU) tone plan for the distribution bandwidth; and
responsive to receiving the trigger frame, transmitting the uplink trigger-based PPDU to the AP in the dRU assigned to the STA in accordance with the dRU tone plan for the distribution bandwidth.

8. The method of claim 7, wherein the distribution bandwidth is a 20 Megahertz (MHz) bandwidth and the dRU assigned to the STA is a 52-tone dRU.

9. The method of claim 8, wherein the pilot tones specified by the dRU tone plan for the distribution bandwidth are located at subcarrier indices −116, −102, −90, −76, −62, −48, −36, −22, 22, 36, 48, 62, 76, 90, 102, and 116.

10. The method of claim 7, further comprising:
receiving a downlink PPDU from the AP in the dRU assigned to the STA in accordance with the dRU tone plan for the distribution bandwidth.

11. The method of claim 10, wherein the receiving the downlink PPDU comprises interpreting tones as being data tones or pilot tones in accordance with the dRU tone plan for the distribution bandwidth, wherein the STA uses pilot tones of dRUs not assigned to the STA when receiving the downlink PPDU.

12. The method of claim 7, wherein the trigger frame also solicits a further uplink trigger-based PPDU from a further STA that is assigned to a rRU, wherein the further STA transmits the further uplink trigger-based PPDU in the rRU assigned to the further STA in accordance with a rRU tone plan, wherein the uplink trigger-based PPDU and the further uplink trigger-based PPDU are transmitted simultaneously.

13. The method of claim 7, wherein the transmitting the uplink trigger-based PPDU to the AP comprises transmitting data signals in the set of non-contiguous data tones of the dRU assigned to the STA and transmitting pilot signals in a set of pilot tones of the dRU assigned to the STA in accordance with the dRU tone plan for the distribution bandwidth.

14. A wireless device to implement a access point (AP) to receive uplink trigger-based physical layer protocol data units (PPDUs) from stations (STAs) in accordance with a distributed tone resource unit (dRU) tone plan for a distribution bandwidth, the wireless device comprising:
a radio frequency transceiver;
a memory device storing a set of instructions; and
a processor coupled to the memory device, wherein the set of instructions, when executed by the processor, causes the AP to:
assign dRUs to the STAs in the distribution bandwidth, wherein the dRU tone plan for the distribution bandwidth specifies a set of non-contiguous data tones within the distribution bandwidth for each of the dRUs, wherein the dRU tone plan for the distribution bandwidth further specifies pilot tones that are located at the same subcarrier indices as pilot tones specified by a regular non-distributed tone resource unit (rRU) tone plan for the distribution bandwidth;
solicit the uplink trigger-based PPDUs from the STAs in accordance with the assignment of the dRUs; and
receive the uplink trigger-based PPDUs from the STAs in the dRUs assigned to the STAs in accordance with the dRU tone plan for the distribution bandwidth.

15. The wireless device of claim 14, wherein the distribution bandwidth is a 20 Megahertz (MHz) bandwidth and the dRUs are 52-tone dRUs.

16. The wireless device of claim 15, wherein the pilot tones specified by the dRU tone plan for the distribution bandwidth are located at subcarrier indices −116, −102, −90, −76, −62, −48, −36, −22, 22, 36, 48, 62, 76, 90, 102, and 116.

17. The wireless device of claim 14, wherein the set of instructions, when executed by the processor, further causes the AP to:
transmit a downlink PPDU to the STAs in the dRUs assigned to the STAs in accordance with the dRU tone plan for the distribution bandwidth.

18. A wireless device to implement a station (STA) to transmit an uplink trigger-based physical layer protocol data unit (PPDU) to an access point (AP) in accordance with a distributed tone resource unit (dRU) tone plan for a distribution bandwidth, the wireless device comprising:
a radio frequency transceiver;
a memory device storing a set of instructions; and
a processor coupled to the memory device, wherein the set of instructions, when executed by the processor, causes the STA to:
receive, from the access point (AP), a trigger frame that solicits the uplink trigger-based PPDU from the STA, wherein the frame includes an indication of a dRU assigned to the STA within the distribution bandwidth, wherein the dRU tone plan for the distribution bandwidth specifies a set of non-contiguous data tones within the distribution bandwidth for the dRU assigned to the STA, wherein the dRU tone plan for the distribution bandwidth further specifies pilot tones that are located at the same subcarrier indices as pilot tones specified by a regular non-distributed tone resource unit (rRU) tone plan for the distribution bandwidth; and
responsive to receiving the trigger frame, transmit the uplink trigger-based PPDU to the AP in the dRU assigned to the STA in accordance with the dRU tone plan for the distribution bandwidth.

19. The wireless device of claim 18, wherein the set of instructions, when executed by the processor, further causes the STA to:
receive a downlink PPDU from the AP in the dRU assigned to the STA in accordance with the dRU tone plan for the distribution bandwidth.

20. The wireless device of claim 19, wherein the receiving the downlink PPDU comprises interpreting tones as being data tones or pilot tones in accordance with the dRU tone plan for the distribution bandwidth, wherein the STA uses pilot tones of dRUs not assigned to the STA when receiving the downlink PPDU.
